(19) United States
(12) Patent Application Publication
(10) Pub. No.: US 2017/0316582 A1
(43) Pub. Date: Nov. 2, 2017

(54) Robust Head Pose Estimation with a Depth Camera

(71) Applicant: BELLUS3D, Los Gatos, CA (US)

(72) Inventor: Shenchang Eric Chen, Los Gatos, CA (US)

(21) Appl. No.: 15/499,733

(22) Filed: Apr. 27, 2017

Related U.S. Application Data
(60) Provisional application No. 62/328,555, filed on Apr. 27, 2016.

(51) Int. Cl. G06T 7/73; H04N 5/232; G06T 17/20; H04N 13/02

(52) U.S. Cl. CPC G06T 7/75; H04N 5/23222; G06T 17/20; G06T 2207/10028; H04N 13/025; G06T 2207/30201

(57) ABSTRACT

The subject invention cover systems and methods for estimating head pose data from a sequence of depth images of a human subject, and processing the data to generate a continuous estimate of the head pose in a 3-dimensional (3D) space, and to generate a 3D head model for display and exploitation by a human subject. The invention includes a method for capturing head pose data in which the subject is provided instructions to rotate their head in a first direction until a threshold angle of rotation is reached and then are provided instructions to rotate their head in a second direction.

### BACKGROUND

Human head pose estimation, or head pose estimation as it is commonly referred to, refers to the extraction of 3 dimensional (3D) information that estimates the location and orientation of a person's head using a sequence of digital images of the head taken from a number of angles. Head pose estimation is a step in several computer vision systems. Also, head pose estimation can provide a natural user interface in many computer applications. By knowing the head orientation and position, a computer application can display information responding to the gaze direction of a human operator. One example is a virtual reality application that can generate a view of the virtual world by tracking the viewpoint of a user. Another example is to use the head pose as input for user interactions, such as selecting text or scrolling a document, which allows physically impaired users to control the computer without using a mouse or a keyboard.

The recent introduction of low cost, commercially available depth sensing cameras makes it possible to generate 3D head models for consumer applications. Depth cameras, as they are referred to herein, provide distance, or depth, images of objects in the field of view of the camera in real-time. By taking multiple depth images of a human head from different directions and computing their head pose data, it is possible to combine the depth images to generate a 3D head model. Examples of commercially available depth cameras are KINECT by MICROSOFT, PRIMESENSE by APPLE COMPUTER, and the BELLUS3D FACE CAMERA.

### Review of Prior Art

Robust head pose estimation remains a challenging problem. Prior art methods largely fall into one or more of the following categories:

(1) Methods that use special markers on a user's face to generate head pose information. These methods, while used extensively in motion capture, are not suitable for consumer applications. They often require the use of multiple cameras, carefully calibrated in a studio environment, and the videos are usually processed offline, not real time.

(2) Methods that use facial feature tracking to obtain the head pose information. These methods typically don't work for a wide range of head poses as some or most facial features disappear when the head turns away from the camera. They are also not very accurate as facial features often change with facial expressions and may be affected by lighting conditions. They also don't work well when there is more than one face presence or a face is partially occluded. Some methods require the use of a second camera to overcome these limitations.

(3) Methods that require training or prior training data: These methods can achieve a higher level of accuracy but they often require a large set of training data captured from many subjects in difference head poses. Some methods also require a user to go through a training session first.

(4) Those that use GPU to achieve real time performance: To achieve real time performance, some methods require the use of a specialized graphic processor (GPU).

Use of the technology to generate 3D head models for consumer applications such as sharing, printing and social networking has been hindered by relatively cumbersome approaches to capturing head pose data. Thus, there is a need for a system and method that extracts human head pose in order to create a 3 dimensional model of a head to be used for consumer applications. For example, some consumer applications direct a user to wave or move a depth camera around the head; but this approach requires an additional operator to perform the scan. What is needed is a solution that allows a user to perform self-scanning by turning his/her head in front of a depth camera in order to capture depth images from different directions.

Thus, there is an opportunity to use low cost depth cameras to generate 3D head models for consumer applications. It is with respect to these considerations and others that the present invention has been made.

### SUMMARY OF THE DESCRIPTION

Various embodiments of the subject invention cover systems and methods for estimating head pose data from a sequence of depth images of a human subject, and processing the data to generate a continuous estimate of the head pose in a 3-dimensional (3D) space, and to generate a 3D head model for display to and exploitation by the subject.

The invention includes a method for capturing head pose data in which the subject is directed to rotate their head in a first direction until a threshold angle of rotation is reached and then to rotate their head in a second direction. The method automatically detects when the subject's head is facing in an acceptable frontal position and then provides a first set of instructions to the subject to rotate his/her head in a first direction. The method automatically detects when the threshold rotation angle is reached in the first direction and then provides a second set of instructions to the subject to rotate his/her head in a second, opposite, direction.

In certain embodiments, the following method is employed for processing successive frames of data: (1) an initial frame, or image, that includes depth and color data is captured with the user facing the camera and established as the initial reference frame. The head region is identified in the frame to extract a 3D head mesh. (2) A second head mesh is extracted similarly in a subsequent frame. (3) The second head mesh is registered with the initial head mesh in 3D to compute a second transformation matrix that aligns both meshes. The matrix is used to compute the rotation and translation head pose for the second frame. (4) A third head mesh is extracted from a third frame, and is transformed by the second transformation matrix to its estimated location. The transformed third head mesh is then registered with the initial head mesh to compute a third transformation matrix, which is used to compute the head pose for the third frame.

To extend the head pose estimation range, additional reference frames are added automatically when the user's head rotation exceeds certain angle. Subsequent frames are registered with a reference frame that has the closest estimated orientation.

Certain embodiments include the detection and recovery from tracking failures, saving of the head mesh data of a user, and auto recognition and tracking of a returning user.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1A shows an embodiment of a head pose estimation system in which a depth camera is connected to a processing device and the processing device is connected to a display.

FIG. 1B illustrates an embodiment of a head pose estimation system in which a depth camera connects to a mobile device.

FIG. 1C illustrates an embodiment of a head pose estimation system in which a mobile device includes a depth sensor, a processor, static memory for storing program code and data and a display.

FIG. 2 shows an embodiment of system in which a depth camera is attached to a mobile device, which is mounted on a tripod.

FIG. 2B illustrates one embodiment of a user interface of a mobile application that enables a user to place an order for prescription medicine from a pharmacy.

FIG. 3A shows a sequence of views of a subject's face as he turns his head from one side to another.

FIG. 3B is a downward looking illustration of how a sequence of overlapping views from a camera or depth camera combine to capture the face of a subject.

FIG. 4A provides an exemplary flow diagram of a method performed by a processing device or mobile device in order to capture and generate a 3D model of a subject's head.

FIG. 4B is an exemplary block diagram that illustrates the software modules that operate in a processing device or mobile device that perform head pose estimation and session control in order to construct a 3D model of a subject's face.

FIG. 5A provides an embodiment of a user interface that instructs a subject to press a control in order for depth camera to begin capturing scene data.

FIG. 5B provides an embodiment of a user interface that presents the subject with instructions to turn his/her head to the left.

FIG. 5C provides an embodiment of a user interface that instructs the subject to turn his/her head to the right.

FIG. 5D provides an embodiment of a user interface in which a message appears that indicates that capture is complete.

FIG. 5E provides an embodiment of a user interface that displays a complete 3D head model.

FIG. 6 is a flow diagram that illustrates one embodiment of a method for capturing head pose data of a subject from a depth camera.

FIG. 7 is a flow diagram that depicts one embodiment of a method for estimating head pose.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Depth camera, also known as depth sensing camera may include structured-light, active or passive stereo, or time-of-flight cameras—provides a sequence of distance, or depth, images of objects in the field of view. For purposes of the subject invention it is assumed that the depth camera generates both depth or range information and color information at video frame rates of at least 5 frames per second (fps). If the frame rate is substantially faster or slower than the subject invention will compensate appropriately.

Subject or user—a person whose head pose is estimated based on sensor input data from a depth camera. In certain embodiments, the subject moves his/her head in a predefined manner during the capture phase.

### Generalized Operation

The following description is based on the case of tracking a single user's head to generate the head pose information. It is also possible to track multiple users' heads concurrently using the same method. It should also be evident, with some change of initialization parameters, to configure the system to track non-human heads or other body parts, such as a human hand. Further, the description covers the case where during capture the user moves their head first to one side and then to another to create a frontal, side-to-side, model of the user's head. It may be appreciated by one skilled in the art that the same technique can be used in the case where a user moves their head upward and downward, or in any combination of head movements in a single pass or in multiple passes.

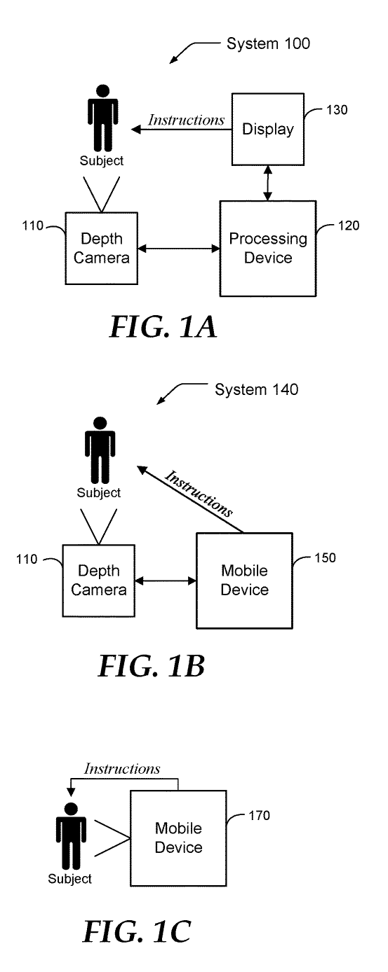

The operation of certain aspects of the invention is described below with respect to FIGS. 1-6.

FIGS. 1A-C present three different embodiments of a system that captures head pose data using a depth camera and stitches successive photos or video frames to create a model of the subject's head. FIG. 1A shows an embodiment of a system 100 in which a depth camera 110 is connected to a processing device 120 and the processing device 120 is connected to a display 130. Depth camera 110 may be a separate camera with a depth feature or a specialized depth camera. Processing device 120 may be a personal computer, tablet computer, mobile device or other computer system with a processor and non transitory memory for storing program instructions and data. Display 130 is connected to processing device 120 wirelessly or using a connector such as a DVI cable or APPLE Display Connector (ADC). This embodiment covers the case where a depth camera is attached to a separate personal computer or laptop computer.

FIG. 1B illustrates an embodiment of a system 140 in which a depth camera 110 connects to a mobile device 150. The connection may be wireless, via a USB connector, an APPLE LIGHTENING connector, or the like. In this case, mobile device 150 performs processing and includes a display. Mobile device 150 is typically a commercially available mobile device or smartphone such as an APPLE IPHONE or a SAMSUNG GALAXY.

Finally, FIG. 1C illustrates an embodiment of a mobile device 170 that includes depth sensing, a processor, static memory for storing program code and data and a display. Thus, mobile device 170 integrates all elements necessary to capture head pose, generate a 3D model, interact with the subject during the capture phase and present results on an integrated display. Mobile device 170 is typically a commercially available mobile device that integrates a depth camera. It is anticipated that such mobile devices will soon be commercially available.

In each of FIGS. 1A-C, the processing device (i.e. processing device 120 or mobile device 150 or mobile device 170) displays instructions and visual feedback to a subject whose face is being captured to estimate head pose. Instructions may also be auditory and haptic.

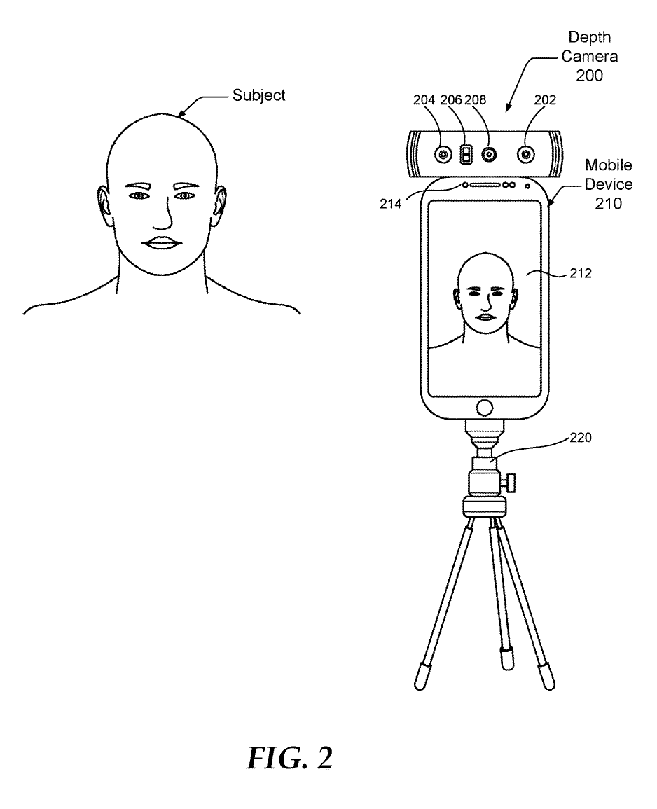

FIG. 2 shows an embodiment of system 140 in which a depth camera 200 is attached to a mobile device 210 which is mounted on a tripod 220.

Depth camera 220 include 2 infrared sensors 202, 204, an infrared laser projector 206 structured for infrared light and a color sensor 208. In certain embodiments, the system will work with color data from a color sensor 214 integrated into mobile device 210. While the infrared sensors and projection provide a depth map of a scene, the color sensors 208 and 214 generate a 2D visible light array of pixels, i.e. a digital image.

Mobile device 212 includes a display 210. Typically, the subject is facing display 212 so that he/she can view instructions and results shown on display 212. The subject follows the displayed instructions and turns his head appropriately so that the entire face, typically between 180 degrees and 360 degrees of rotation, is captured.

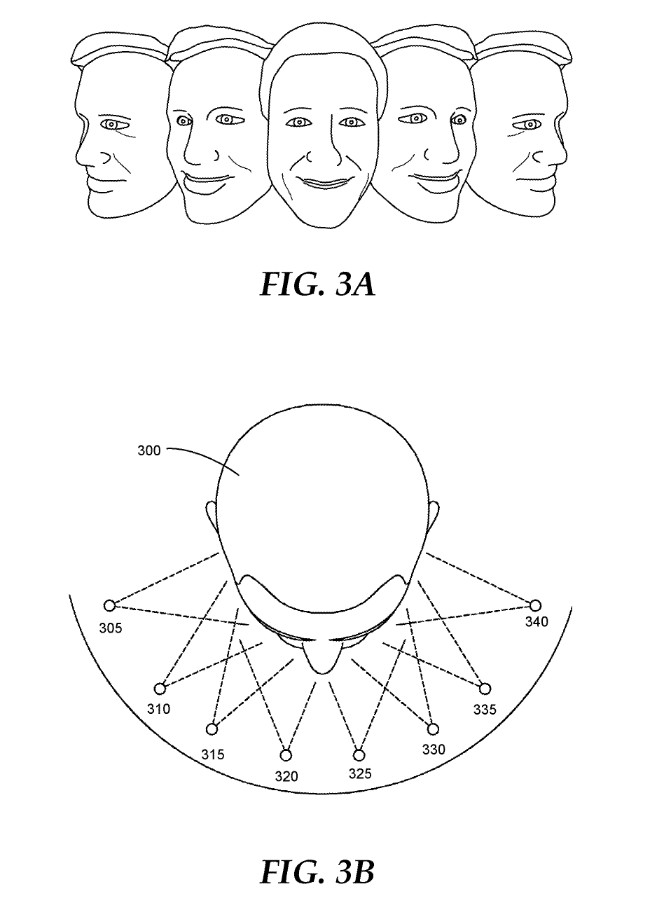

FIGS. 3A and 3B illustrate an embodiment of the capture process. FIG. 3A shows a sequence of views of a subject's face as he turns his head from one side to another. FIG. 3B is a downward looking illustration of how a sequence of overlapping views from a camera or depth camera combine to capture the face of a subject 300. Essentially views 305-340 capture roughly 180 degrees of the face of subject 300. The subject invention combines, or “stitches”. successive frames of captured data together to create a depth map and a color map, the map is then applied to a cylinder to create a 3D model. It may be appreciated that the map can also be applied to a sphere or other geometric shape. Thus, in FIG. 3B, the 8 views illustrated in FIG. 3B must be stitched together and then mapped onto a cylinder to yield a 3D model.

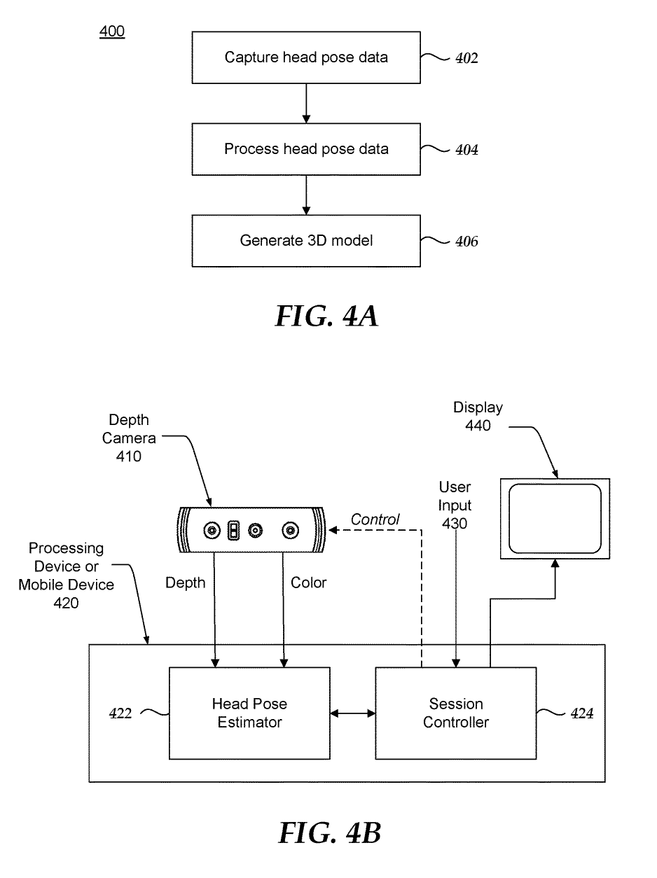

FIG. 4A provides an exemplary flow diagram of a method 400 performed by a processing device or mobile device in order to capture and generate a 3D model of a subject's head. At step 402 a subject's head is captured by a depth camera and color and depth data is provided to a processing device or mobile device for processing.

At step 404 the depth and color data is processed to create meshes.

At step 404 a 3D model is created and is provided to the subject, for display and or printing, sharing via social media or email, or for other purposes.

It may be appreciated that the data captured at step 402 is a series of frames, each frame capture a slightly different angle of the subject head. In certain embodiments, at step 404 the frame data is processed in real time and real time display information is provided to the subject.

FIG. 4B is an exemplary block diagram that illustrates the software modules that operate in a processing device or mobile device 420 (henceforth “device 420”) that perform head pose estimation and session control in order to construct a 3D model of a subject's face. This block diagram is valid for each of the system configurations illustrated in FIGS. 1A-1C.

A depth camera 410 capable of capturing both color and depth data connects to and provides depth data and color image data to device 420. Device 420 processes the data and displays results and instructions on a display 440. Device 420 is a computing device with a processor and nontransitory memory for storing program code and data. It also includes data storage. In the configurations illustrated in FIGS. 1A-1C device 420 corresponds to processing device 120, mobile device 150 and mobile device 170, respectively. As discussed with reference to FIG. 1C depth camera 410 may be integrated with device 420. Likewise display 440 may be integrated with processing device 420, as is the case with mobile device 150 and 170.

A software module referred to as head pose estimator 422 runs on device 420 and processes the depth and color data received from depth camera 410 in real time to generate 6 degree-of-freedom (three rotational and three translational) head pose data. Head pose estimator 422 may optionally display a video of the user's head superimposed with directional axes showing the orientation of the head, generated by head pose estimator 422 on display 440.

A software module referred to as session controller 424 runs on device 420 and uses the head pose data created by head pose estimator 422 to control functions related to management of a session. A session refers to capturing head pose data for a subject, processing the data and providing a 3D model to the subject for exploitation. In certain embodiments, head pose estimator 422 and session controller 424 may run on different computer devices. Session controller 424 may obtain the head pose data from head pose estimator 422 in real time via an API (application programmer's interface), or via a local or remote network connection, in the case that session controller 424 runs on a different computer than head pose estimator 422.

In a typical use case, session controller 424 launches head pose estimator 422 and requests it, via an API or a network connection, to start a tracking session during which head pose data is captured, processed and returned to session controller 424 in real-time. Real-time in this case is typically 30 Hz, i.e. the data is processed at the same rate that frames are received. In certain embodiments, the frame rate may be less than 30 fps (frames per second) and in certain embodiments the frame rate may be greater than 30 fps. Session controller 424 may terminate or restart a tracking session as needed.

To start a tracking session, head pose estimator 422 requires a subject to face depth camera 410 to capture an initial reference frame (“Initial Reference Frame”), to which subsequent frames are compared. Head pose estimator 422 can be configured to start the tracking automatically or manually. In the automatic case, head pose estimator 422 continuously monitors the incoming data to detect presence of a human face in the input video stream of frames. When a stable frontal face is detected for some preset period of time (e.g 2-5 seconds), the tracking starts. In the manual case, the user is instructed to face the depth camera and then press a key or to click a button on the screen to initiate the tracking.

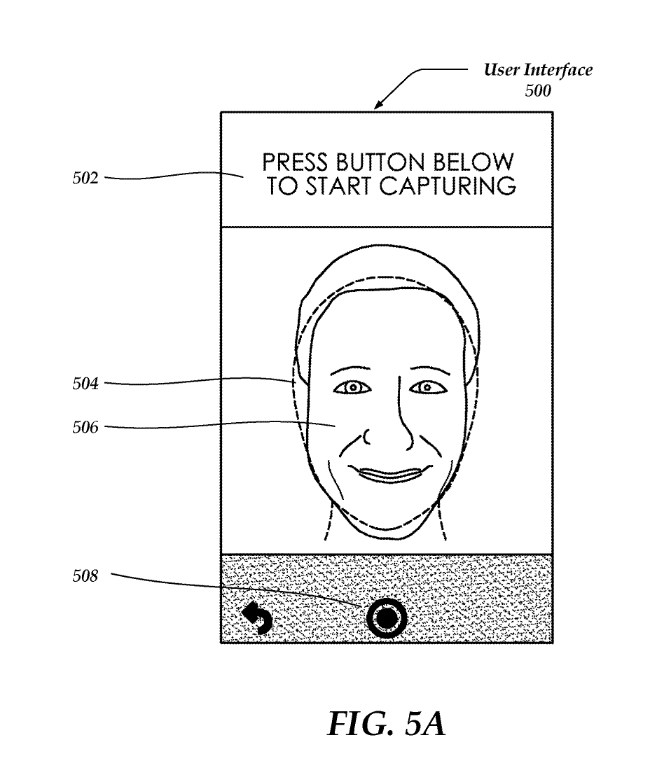

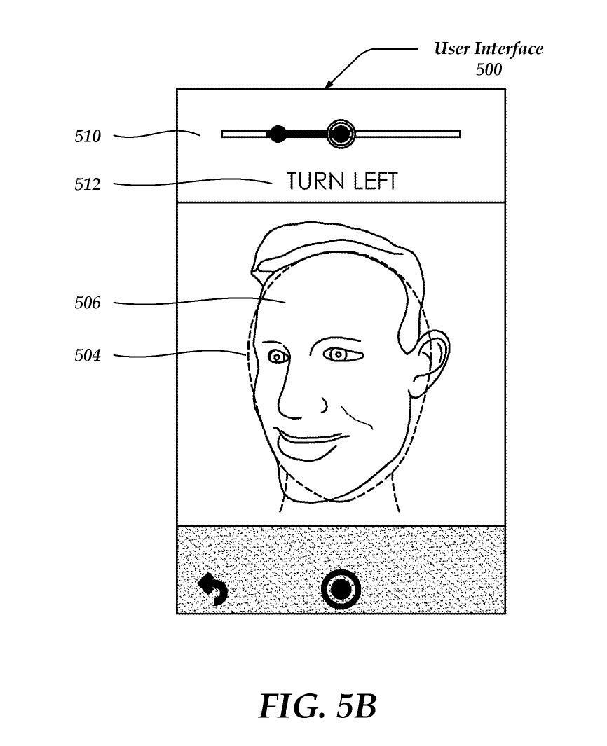

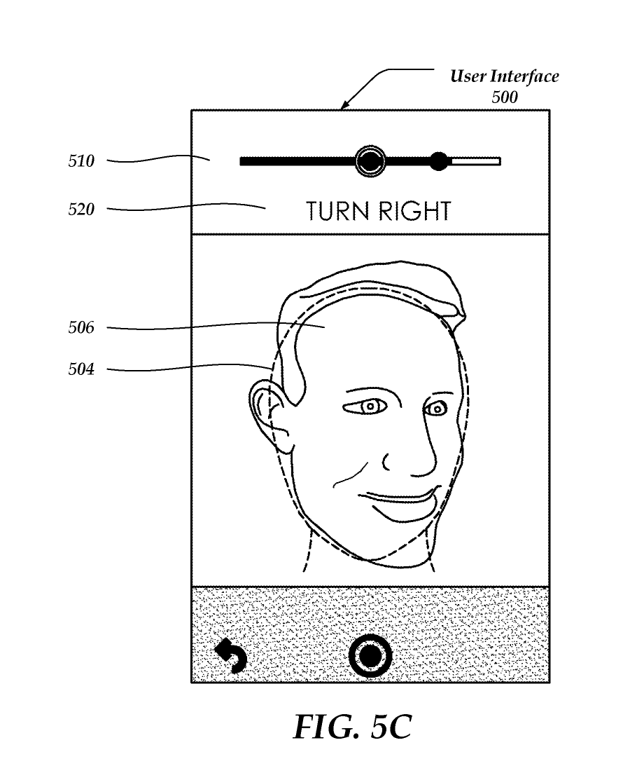

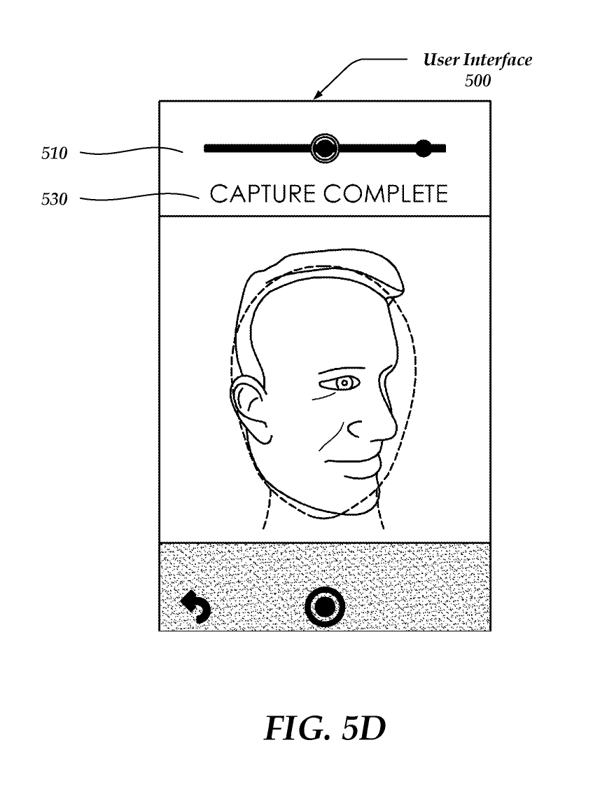

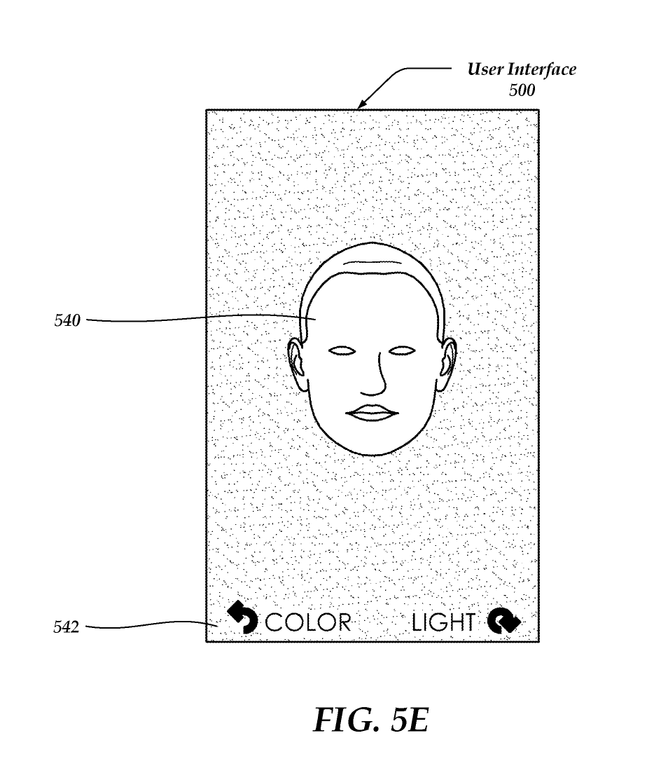

FIGS. 5A-5E provide an embodiment of a user interface 500 that instructs a subject to turn his/her head in a prescribed manner in so that a depth camera can efficiently capture a complete face. The approach relies on a configuration such as that illustrated in FIG. 2 and an approach as illustrated in FIGS. 3A-3B in which the depth camera 200 remains fixed while the subject turns his head first in a prescribed manner so as to allow the depth camera to capture a sequence of images of one side of the face and then the other.

As illustrated in FIG. 5A, an initial set of instructions 502 appears that instructs the user to press a control 508 in order for depth camera 410 to begin capturing scene data. The subject's face 506 appears on display 440. Generally, the method will wait until the subject positions himself/herself in front of the camera such that their face roughly fits within a contour 504 and remains in that position for a short period of time, e.g. 2-5 seconds. Additional instructions may be provided as necessary to instruct the subject to correctly position himself/herself. Additional controls such as a “back” control may also be available at this point.

As illustrated in FIG. 5B, after pressing control 508 the subject is presented instructions 512 to turn his/her head to the left. As the subject turns his/her head to the left: (1) a progress bar 510 indicates what portion of the face has been captured thus far, and (2) the face of the subject 506 as seen by the depth camera is continuously updated. Generally, it is assumed that the depth camera receives a continuous feed of images at 30 fps. If the subject's face is within contour 504 then this operation continues until the left side of progress bar 510 is full, which occurs when the subject has turned their head approximately 90 degrees to the left. In other embodiments, a user may continue to rotate, for example by swiveling on a chair in order to capture the back of their head.

As illustrated in FIG. 5C, when the subject has turned his/her head approximately 90 degrees to the left a message 520 appears on the display instructing the subject to turn his/her head to the right. At this point the left side of progress bar 510 indicates that capture on the right side of the face, i.e. the side of the face turned towards depth camera 410 when the user turns their head to the left, has completed. The display of subject's face 506 continues to update in real-time as depth camera 410 now captures the right side of the subject's face.

As illustrated in FIG. 5D, when the subject has turned approximately 90 degrees to the right a message 530 appears on the display indicating that capture is complete. At this point progress bar 510 indicates that facial capture by depth camera 410 has completed.

As illustrated in FIG. 5E, after capture is complete, head pose estimator 422 completes its calculations and can provide a complete 3D head model to session controller 424 for display to the subject via display 440. This step is optional but is likely to be desirable in most consumer applications. A variety of user-controls 542 can be provided to the subject. For example, color controls can be used to add, subtract, or filter color values. Additionally, a lighting control may be provided that enables the user to control lighting on the 3D model, for example to shift the location of the lighting source, type of light, intensity, etc.

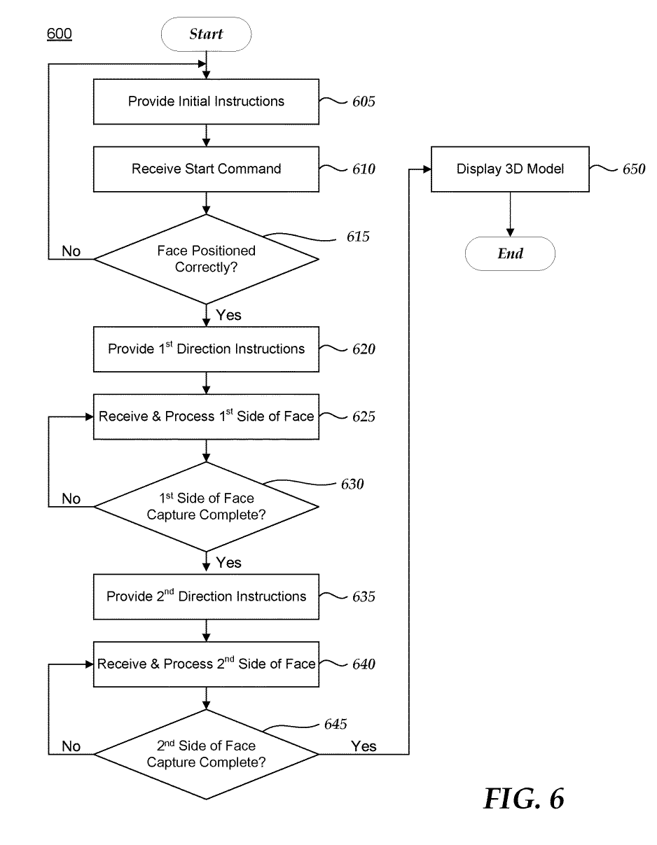

FIG. 6 is a flow diagram that illustrates one embodiment of a method 600 performed by device 420 to capture head pose data of a subject from a depth camera. Method 600 generally conforms to the sequence of interactions and processing described with reference to FIGS. 5A-5E, hereinabove. However, method 600 is more general and independent of the specific user interface design, the depth camera and the underlying technology used to process captured head pose data.

A step 605, device 420 provides initial instructions to the subject. Typically, device 420 causes starting instructions to the subject about how to position their head correctly to be presented on display 440 and instructs the subject to press a start control to initiate capture. In certain embodiments, these initial instructions are not required and device 420 automatically detects that a subject's face is correctly positioned in the field of view and moves to step 620.

At step 610, device 420 receives a start command based on input from the subject such as clicking a menu item or selecting a control. Again, in embodiments of the subject invention this step may be automated and once device 420 detects that a subject's head is positioned correctly processing flows to step 420. Thus, step 610 can be considered as an optional step.

At step 615, device 420 determines whether the subject's face is correctly positioned. For example, as illustrated in FIG. 5A a subject's face may be required to fall substantially within contour 504. Generally, at any point of method 600 it may be required that the subject's face be positioned so that it is substantially within contour 504. Essentially, this means that the face is centered and wholly within the field of view of depth camera 410. If a subject's face at any point move's outside contour 504, i.e. it moves outside the field of view of depth camera 410, then corrective action such as starting over, or displaying a message directing the subject to reposition their head may be taken. If the face is determined to be correctly positioned then processing continues at step 620. If not, then there are several alternatives: (1) in certain embodiments, processing returns to step 605 and the initial instructions to the subject are repeated, potentially with some additional information, (2) processing can continue at step 615 while the subject makes attempts to position their face correctly.

At step 620 a first set of direction instructions are provided to the subject. Typically, device 420 causes instructions to the subject to be presented on display 440 that instruct the subject to turn their head in a first direction. In example user interface 500 the subject was instructed first to turn his/her head to the left. However, in other embodiments the subject may be instructed to first turn his/her head to the right or to move the head upwards or downwards. If the user is seated on a swivel chair the instructions may suggest that the subject swivel the chair in one direction or another.

At step 625, as the subject moves his/her head as instructed at step 620, processing device 420 receives a sequence of images from the field of view of the camera. As it receives the image sequence, device 420 computes a continuous head pose estimate of the current image from the previously received images. Typically, device 420 provides continuous updates to display 440 at this step, including showing the sequence of image. For example, the received images may be displayed to the subject a progress bar may be updated. Other types of real-time feedback may also be provided such as visual or auditory encouragement.

At step 630, while images from depth camera 410 are being received, device 420 analyzes the images to determine if capture of the 1^{st} side of the face is complete. This can occur if (1) the face has turned to a predetermined angle from the starting position, (2) the face stops turning for a pre-determined amount of time, e.g. 5 seconds, or (3) the face starts turning, back, i.e. in the opposite direction. As an example of case 1, if the starting position, in which the subject is facing front, with zero head rotation, is considered to be (x=0,y=0, z=0) in a 3D coordinate system then the finishing point may be (x=0, y=90, z=0), i.e. the head is turned 90 degrees. In this coordinate system, typically used for computer vision, the y axis represents degrees of yaw, moving the head right to left, the x axis represents degrees of pitch, moving the head up and down, and the z axis represents degrees of pitch, the tilt of the head. When capture of the 1^{st} side of the face is complete processing continues at step 635. Generally, steps 620 and 625 are performed continuously, in real-time, for every successive frame or image received from depth camera 410. Further, device 420 may provide continuous updates to display 440 at this step. For example, a progress bar may be updated and the received images may be displayed to the subject. Other types of real-time feedback may also be provided, including visual or auditory information.

At step 635, a second set of direction instructions are provided to the subject. Typically, device 420 causes instructions to the subject to be presented on display 440 that instruct the subject to turn their head in a second direction. In example user interface 500, the subject was instructed first to turn his/her head to the left and second to turn his/her head to the right.

At step 640, as the subject moves his/her head as instructed at step 635, processing device 420 receives a sequence of images from the field of view of the camera. As in step 625, as it receives the image sequence, device 420 computes a continuous head pose estimate, or head mesh, from the received images that depict the head at various rotation angles. Typically, device 420 provides continuous updates to display 440 at this step, including showing the sequence of image. For example, the received images may be displayed to the subject a progress bar may be updated. Other types of real-time feedback may also be provided such as visual or auditory encouragement.

At step 645, while images from depth camera 410 are being received, device 420 analyzes the images to determine if capture of the 2nd side of the face is complete. This can occur if (1) the face has turned to a predetermined angle from the starting position, (2) the face stops turning for a pre-determined amount of time, e.g. 5 seconds, (3) the face starts turning, back, i.e. in the opposite direction, (4) device 420 receives an input command to halt the head pose estimation process. As an example of case 1, if the starting position is considered to be (x=0,y=0, z=0), where the units are degrees, then the finishing point may be (x=−90, y=0, z=0), where x is the horizontal axis in which motion occurs and z refers to up and down, or latitudinal, motion of the head. When capture of the 2nd side of the face is complete then the face capture is complete and processing continues at step 650. Generally, steps 640 and 645 are performed continuously, in real-time, for every successive frame or image received from depth camera 410.

At step 650 the 3D model, i.e. the head mesh, is optionally displayed on display 440. Other types of actions may be performed by the user but capture of the facial data and estimation of head pose is complete at this point.

### Head Pose Estimation

The goal of head pose estimator 422 is to compute 3 rotational and 3 translational head pose parameters that correspond to the orientation and location of the head in 3D relative to an Initial Reference Frame. The following describes the steps head pose estimator 422 takes to generate the head pose data from the input color and depth video data.

Estimation with Initial Reference Frame

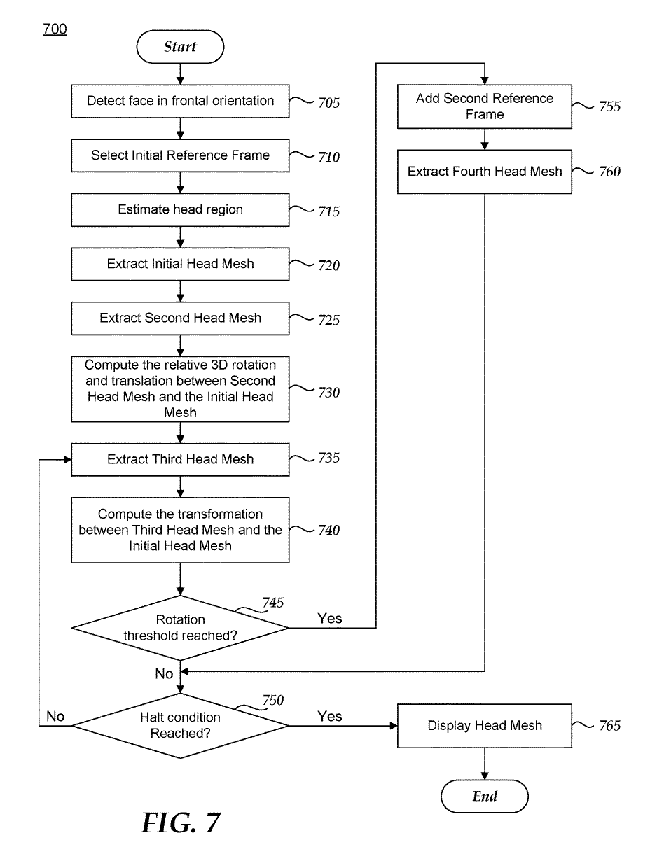

FIG. 7 is a flow diagram that depicts one embodiment of a method performed by device 420 for estimating head pose. The method operates on a sequence of received frames provided by depth camera 410.

At step 705, the received frames are analyzed to detect the presence of a human face in a frontal orientation using a face detection algorithm. A face is considered in a frontal orientation when two eyes are detected inside the face in a symmetrical location above the center and a nose tip just below the center of the face region. The face and the eyes are detected from the color image using a feature detection algorithm such as Haar Cascade. Note that a tutorial covering the basics of face detection using Haar Feature-based Cascade Classifiers is available at http://docs.opencv.org/trunk/d7/d8b/tutorial_py_face_detection.html. The nose tip is detected by examining the depth data inside the face region looking for the closest point with a cone shaped curvature. It should be noted that Haar Cascade detection works from a set of training data, and can be configured to use other data to detect different subjects, such as human hands or other objects, and is not limited to human faces and eyes only. This allows the proposed method to work on subjects other than human head as noted earlier. It should also be noted that the frontal face orientation is desirable because most applications prefer the head pose to be relative to the camera's orientation and the frontal face allows the reference frame and the camera's orientation to be roughly aligned. However, it is not required in our method to use a frontal face for the Initial Reference Frame. There may be cases where the head pose should be based on a reference frame captured when the user is looking away from the camera.

At step 710, when a face is detected in a desired orientation in the automatic mode, or when the user presses a key in the manual mode, an Initial Reference Frame is captured or selected. Captured frames are assumed to include both color and depth information. The Initial Reference Frame establishes the origin of a coordinate system on which the subsequent head pose data are based. The head pose data of subsequent frames will be relative to the orientation and location of the Initial Reference Frame.

At step 715, An image-space bounding box of the head region (“Head Region Estimate”) is estimated. For the Initial Reference Frame, the estimate is obtained from Haar Cascade face detection in Step 1. For subsequent frames, the initial estimate is transformed using the computed head pose data to its new location.

At step 720, an Initial Head Mesh is extracted from inside the Head Region Estimate generated at step 715. Pixels from the captured sequence of frames may belong to the head or to the background. To extract only the head pixels, pixels are removed whose depth values are greater than a predefined prescribed distance (say 4 feet) away. Next an average depth value of all the remaining pixels is used as an estimate of the distance of the head from the camera. Since some head pixels may fall outside of the Head Region Estimate, we grow the region by connecting any adjacent pixels whose depth values are within some threshold of the average depth value of the head. Finally, since we know roughly the size of a human head, we can determine the image size of the head from the distance, and then compute a bounding box with the image size centered at the head pixel region. The result is a mesh of pixels with X, Y, and Z coordinates that belongs to the head in its initial orientation (referred to as an “Initial Head Mesh”.) Initial Head Mesh is assigned an identity 3D transformation matrix (referred to an “Initial Reference Transformation”).

At step 725, a Second Head Mesh is extracted from a subsequent video frame after the Initial Reference Frame using the method from the previous step (step 720). This step assumes that method 700 is being performed at video rates and a human head moves only a small amount between each successive video frame.

At step 730 the relative 3D rotation and translation between Second Head Mesh and the Initial Head Mesh is computed. In certain embodiments, this is performed using Iterative Closest Point (“ICP”). ICP is a well-established algorithm to find the relative transformation between two sets of 3D points. One article that describes ICP is Chen, Yang; Gerard Medioni (1991). “Object modelling by registration of multiple range images”. Image Vision Comput. Newton, Mass., USA: Butterworth-Heinemann: pp. 145-155. ICP requires the two sets of points to be roughly aligned and it can then iteratively find a best transformation that minimizes some objective measurement such as the mean distance between the points. ICP converges faster when the two sets are already closely aligned and the data have substantial overlaps. Unlike feature-based methods, ICP may use all data points and does not require establishing of point correspondences so it is more fault-tolerant. ICP's speed depends on the number of iterations and the closer the initial alignment, the faster the convergence speed. Method 700 tracks data points at video rates so ICP can converge very fast enabling the estimation of 3D rotation and translation to be performed in real time. The output from ICP is a transformation matrix that when applied to the Initial Head Mesh will align it with the Second Head Mesh. We can then compute the head pose data of the Second Head Mesh by inverting the transformation matrix and extract the rotation and translational parameters using standard formulas.

At step 735 a Third Head Mesh is extracted from a subsequent frame: The Head Region Estimate is transformed using the transformation matrix computed in the preceding step (step 730) to create an estimate of the head region for the third frame and then the method of step 720 to extract the new head mesh from the subsequent frame.

At step 740, the transformation between the Third Head Mesh and the Initial Head Mesh is computed. The Initial Head Mesh is transformed to roughly match the orientation and location of the Third Head Mesh using the transformation matrix computed in step 730, and then ICP is used to compute the relative transformation between the Third Head Mesh and the Initial Head Mesh. The inverse of the matrix is used to compute the head pose data of the Third Head Mesh. It should be noted that this method does not suffer the same drift problems that certain other methods suffer where they are concatenating transformations computed from successive frames and accumulating the errors. This method always computes the transformation between the current frame and the Initial Reference Frame. The method uses the previous transformation only to set the initial alignment between the current frame and the initial frame for ICP to speed up convergence and reduce errors.

### Extending the Estimation Range

Steps 735 to 740 are repeated to compute the head pose for all subsequent frames. However, as noted earlier, ICP only works if there is a sufficient amount of overlap between two sets of points. Since the current frame is always registered with the initial reference frame, at certain rotation angles, the overlap will not be sufficient for ICP to work properly. Experiments indicated that ICP can be reliably used to compute relative orientations up to 30 degrees from the initial frame. Thus, to extend the head pose estimation beyond that range a new reference frame is added at some interval, such as every 30 degrees of rotation in each rotational axis. Moreover, method 700 automatically determines which reference frame to use based on the orientation of the frame immediately preceding the current frame. Without any loss of generality, the following steps describe the case of adding a second reference frame only; but it may be understood that additional reference frames may be used to extend the rotational range to full 360 degrees.

Thus, at step 745 a determination is made for each received and processed frame as to whether the frame has reached a threshold rotation angle from the Initial Reference Frame. As discussed, a thirty degree experimentally determined value is typically used as the threshold value but other rotation angles may be used. This determination is made based on the rotation angle of the transformation of the Third Head Mesh. If the threshold rotation angle is reached then processing continues at step 755. If not, then processing returns to step 750.

At step 755 a Second Reference Frame is added. The head mesh extracted for the current frame at step 735 is added as a Second Reference Frame, whose relative transformation between itself and the Initial Reference Frame is recorded as Second Reference Transformation. The rotational angle is now associated with the Second Reference Frame.

At step 760, a fourth frame is processed to extract a Fourth Head Mesh, following the procedure described in step 720 (extract initial head mesh). The orientation angle of the frame immediately preceding the fourth frame is used to determine which of the existing reference frames to use for ICP registration with the fourth frame. The reference frame with the smallest rotational angular difference from the immediate preceding one is chosen and ICP is performed to compute the relative transformation between the fourth frame and the chosen reference frame. If Second Reference Frame is chosen in this case, the final transformation of the Fourth Head Mesh is computed by concatenating the transformation between the Fourth Head Mesh and the Second Head Mesh, and the Second Reference Transformation. The final transformation will transform the Fourth Head Mesh to register with the Initial Head Mesh, and the inverse of the final transformation is used to compute the head pose of the Fourth Head Mesh and the fourth frame. Processing then returns to step 750.

At step 750 the head pose estimation process is halted if any of the following conditions are reached: (1) it is terminated by a human operator or another computing process, (2) a pre-defined processing time is reached, or (3) a pre-defined range of head pose data is achieved, such as from −90 to 90 head rotation angles. Once the estimation process is halted processing continues at step 765. If none of the halt conditions are reached then processing returns to step 735 where the next frame is processed.

At step 765, a continuous head mesh that has been created is displayed to the subject. This step is optional, as the objective of method 700 is to build a continuous head mesh that accurately models a subject's head in 3D. The model can be exploited in a variety of ways, including display, sharing via social networks, use in consumer application, etc.

With only two reference frames, the final transformation of any frame can be computed by at most concatenating two transformation matrices. Errors are not accumulated indefinitely, thus creating a data-drifting problem. As more reference frames are added the number of concatenations increases but it is still a small number and doesn't affect the accuracy of the head pose estimation significantly. Most applications don't need more than 90 degrees of rotation. In such case, only three concatenations need at most three concatenations of the transformation matrices are needed at most since the farthest reference frame (60 degrees) is connected to the Initial Reference Frame via only one in-between reference frame (30 degrees).

A reference mesh can be automatically replaced when a newer head mesh of the same orientation as an existing reference mesh is found. This allows the reference meshes to be continuously refreshed with a more updated mesh, which should improve tracking accuracy. To avoid increasing errors, a reference mesh should only be replaced when the newer mesh has equal or lower registration error than the one being replaced.

Error Reporting and Auto Recovery from Tracking Failures

head pose estimator 422 uses the ICP registration error to determine an estimation confidence value and reports that to the Client Program. The confidence value is inversely proportional to the amount of error. The Client Program can choose to discard head pose data with a low confidence value to avoid generating incorrect actions from a wrong head pose.

The above tracking works because it is assumed that the user's head moves smoothly in 3D and the current location can be estimated from the previous location and the transformation. The assumption no longer holds if the user moves rapidly or completely out of sight of the camera. In this case, it is no longer possible to continue the tracking using the previous estimate. head pose estimator 422 can detect when such failures happen by examining the registration error. When the error exceeds certain threshold, a new search is conducted to look for the head region in the entire frame using face detection as in Step 1. Once a frontal face is detected again, a head mesh can be extracted and then registered with the Initial Head Mesh to compute its transformation and the process can then resume.

A problem may occur when there are multiple faces in the frame. The face detection may find more than one face. To resume tracking of the right subject, the head pose estimator can extract a head mesh from each of the found face region. Each of the head meshes is then compared with the Initial Head Mesh to compute a transformation and an error metric for the registration. The head mesh that has the lowest error metric within a prescribed error threshold is deemed the correct subject and the tracking is resumed.

### Saving of Head Meshes for User Recognition

The reference head meshes computed using method 700 represents a continuous 3D model of a subject's head. Each head mesh covers a scan of the head from a direction including some overlap with adjacent meshes.

The reference head meshes can be saved for later use to recognize a returning user. In one embodiment, the head pose tracking will only start when a particular user is recognized. When an Initial Head Mesh is detected and created in Step 1, it can be registered with stored initial head meshes of all candidate users. The candidate user whose initial head mesh has the lowest registration error which is within a prescribed threshold is recognized as the returning user and all of the user's stored reference meshes can be retrieved to initialize the tracking sessions. In this way, the tracking can start with reference meshes from a previous session. The reference meshes can be updated and saved again during the current session as stated before.

To reduce the data size of stored reference meshes, the head meshes can be stored at a lower resolution and/or applied with some standard data compression method.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for estimating head pose, comprising:
detecting that the face of the subject is positioned correctly within the field of view of a depth camera;
providing a first instruction to a human subject regarding a first direction in which to rotate his head;
receiving a first sequence of images from a depth camera wherein the images correspond to a first side of the subject's head;
generating a mesh that that estimates head pose based on the first sequence of images;
determining that that the subject's head has rotated to a threshold angle in the first direction;
providing a second instruction to a human subject regarding the direction in which to rotate his head;
receiving a second sequence of images from the depth camera wherein the images correspond to a first side of the subject's head;
extending the head mesh to further estimate head pose based on the second sequence of images;
determining that the subject's head has rotated to a threshold angle in the second direction; and
displaying the completed head mesh.
